(19) United States
(12) Patent Application Publication
(10) Pub. No.: US 2013/0311471 A1
(43) Pub. Date: Nov. 21, 2013

(54) TIME-SERIES DOCUMENT SUMMARIZATION DEVICE, TIME-SERIES DOCUMENT SUMMARIZATION METHOD AND COMPUTER-READABLE RECORDING MEDIUM

(71) Applicants: Yuzuru Okajima, Tokyo (JP); Satoshi Nakazawa, Tokyo (JP); Takao Kawai, Tokyo (JP)

(72) Inventors: Yuzuru Okajima, Tokyo (JP); Satoshi Nakazawa, Tokyo (JP); Takao Kawai, Tokyo (JP)

(73) Assignee: NEC CORPORATION, Minato-ku, Tokyo (JP)

(21) Appl. No.: 13/982,523

(22) PCT Filed: Dec. 9, 2011
(86) PCT No.: PCT/JP2011/078517

§ 371 Date: Jul. 30, 2013

(30) Foreign Application Priority Data
Feb. 15, 2011 (JP) 2011-029705

(51) Int. Cl. G06F 17/30

(52) U.S. Cl. CPC G06F 17/30705
USPC 707/737

(57) ABSTRACT

A time-series document summarization (201) device outputs a summary sentence of a document-of-interest collection that is a document collection to be an object. A time-series document summarization (201) comprises: a background topic word extraction part (20) configured to acquire a set of the document-of-interest collection and a document-of-interest topic word that is a feature word of the document-of-interest collection, and a reference-use document collection that is a document collection different from the document-of-interest collection, and extract a background topic word representing a topic to be a background of a topic described in the document-of-interest collection from the reference-use document collection; and a representative character string extraction part (30) configured to extract a representative character string including the document-of-interest topic word and the background topic word as a summary sentence of the document-of-interest collection from among character strings included in the document-of-interest collection.

### TECHNICAL FIELD

The present invention relates to a time-series document summarization device, a time-series document summarization method and a computer-readable recording medium, and in particular, relates to the time-series document summarization device, the time-series document summarization method and the computer-readable recording medium which summarize a topic in a document collection and presents it to a user.

### BACKGROUND ART

In recent years, owing to development of the Internet, a huge amount of documents such as news articles and blog articles have come to be generated and exhibited day and night. Consequently, a new technology for summarizing contents of such a huge amount of time-series documents is made to be needed.

As a technology for extracting and summarizing matters of topics from a huge amount of time-series documents, a technology of trend analysis is known. The trend analysis means a technology which analyzes what kind of matter has become a topic and presents it to a user for every period from among a huge amount of documents such as news articles and blog articles generated time-serially.

In the trend analysis technology, with respect to a period-of-interest, it is general to represent a topic in the period by extracting and outputting a feature word appearing a lot in a biased state in a document collection belonging to the period.

In a technology described in Okumura Manabu, Nanno Tomoyuki, Fujiki Toshiaki, Yasuhiro Suzuki, “Text mining based on automatic collection and monitoring of a blog page”, Japanese Society for Artificial Intelligence Study group SIG-SW&ONT-A401-01, 2004 (Non-patent Document 1), a feature word appearing in a specific period a lot in a biased state is made to extracted by determining whether an appearance interval of a document including a certain word has become shorter than usually.

Furthermore, with respect to a feature word in a period-of-interest extracted by using the technology described in Non-patent Document 1, it is easy to extract a sentence including the feature word. It is possible to output a sentence including this feature word as a summary sentence representing a topic in the period.

As an example, there is a service described in “Yahoo! Blog searching”, [online], [August 23, Heisei 22 searching], the Internet <URL: http://blog-sarch.yahoo.co.jp/> (Non-patent Document 2). In this service, a feature word at a current time is indicated in a top page, and when the indicated feature word is clicked, the page changes to a searching page, and apart of a sentence including the clicked feature word is indicated. This corresponds to having presented, to a user, a sentence including a feature word in a period-of-interest as a sentence for describing a topic in the period.

In addition, a technology described in pages 22 to 23 of Okumura Manabu, Nanba Hidetsugu, “Science of Intelligence, Text Automatic Summarizing”, Ohmsha Ltd., 2005 (Non-patent Document 3) is a technology for creating a summary by extracting a sentence including a feature word of a document. By applying this technology to a document collection belonging to a certain period, it is possible to present a summary sentence describing a topic in the period.

In this way, there exists a technology for carrying out presenting as a summary sentence describing a topic in the period by extracting a sentence including a feature word in a certain period.

In addition, as an example of a technology for processing a topic word, a technology as stated in the following is disclosed in Japanese Laid-open Patent Publication 2006-139718 (Patent Document 1). That is, when a topic word and document information associated with the topic word is read in, a document sharing level between a document related to a certain topic word and a document associated with an other topic word is calculated by means of a topic word connection rule stored in a topic word connection storage means. Next, connectable topic words are selected based on the document sharing level, and the selected topic words are connected, and the connected topic words are made to be a topic word group together with the document sharing level. Next, a representative word of the connected topic word group is made to be extracted based on a representative word extraction rule.

In addition, a technology as stated in the following is disclosed in Japanese Laid-open Patent Publication 2007-140602 (Patent Document 2). That is, with respect to each of words and phrases included in a processing object document, an association degree distribution with user of the words and phrases which are acquired by acquiring and making up an association degree between an originating source of a processing object document and an originating source which has used the words and phrases from an association degree database is made to be compared with an association degree distribution with an other originating source which are acquired by acquiring and making up an association degree between the originating source of the processing object document and an other originating source from the association degree database. Then, a quantity representing a degree of being used a lot in an originating source having a large association degree with the originating source of the processing object document is made to be assumed as a topic degree of the words and phrases.

In addition, a technology as stated in the following is disclosed in Japanese Laid-open Patent Publication 2008-152634 (Patent Document 3). That is, by making up a temporal occurrence frequency change of words which appear in a plurality of document collections, a time-series frequency vector of each word is made to be generated. The above-mentioned generated time-series frequency vector of a word is made to be analyzed, and the word where the frequency increases rapidly temporarily is made to be extracted as a candidate word that is a candidate of a potential topic. Among topics included in the above-mentioned document collection, with respect to topics for which the number of documents is more than a prescribed threshold value, a main topic time-series frequency vector is made to be generated by expressing numerically the number of documents acquired for every time. Then, an inter-vector distance between a time-series frequency vector of each candidate word and the above-mentioned main topic time-series frequency vector is made to be calculated, and the word where the distance is large is made to be extracted as a potential topic word.

### PRIOR ART DOCUMENT

### Non-Patent Document

Non-patent Document 1: Okumura Manabu, Nanno Tomoyuki, Fujiki Toshiaki, Yasuhiro Suzuki, “Text mining based on automatic collection and monitoring of a blog page”, Japanese Society for Artificial Intelligence Study group SIG-SW&ONT-A401-01, 2004
Non-patent Document 2: “Yahoo! Blog searching”, [online], [August 23, Heisei 22 searching], the Internet <URL: http://blog-sarch.yahoo.co.jp/>
Non-patent Document 3: Okumura Manabu, Nanba Hidetsugu, “Science of Intelligence, Text Automatic Summarizing”, Ohmsha Ltd., 2005

### Patent Document

Patent Document 1: Japanese Laid-open Patent Publication 2006-139718
Patent Document 2: Japanese Laid-open Patent Publication 2007-140602
Patent Document 3: Japanese Laid-open Patent Publication 2008-152634

### SUMMARY OF THE INVENTION

### Problems to be Solved by the Invention

Meanwhile, a new service referred to as a micro blog like Twitter has begun propagating. In the micro blog like this, a user posts a text assuming a reader who shares a specific small number of background information in many cases.

Consequently, as compared with a conventional news article and blog article, as is the case for a conversation among intimate friends, a part which will be a description with respect to a background is omitted in many cases.

Based on a statistical appearance tendency of a word or expression, in the case where a conventional technology such that a sentence including a feature word may be selected as a summary sentence is used, a sentence in which a part which will be a description with respect to a background is not included is likely to be selected as a summary sentence stochastically. However, for general readers who do not know about a background originally are not able to understand about what the sentence is written, and there is a problem that the sentence becomes inappropriate as a summary sentence.

Then, in Non-patent Documents 1 to 3 and Patent Documents 1 to 3, a configuration for solving such problems has not been disclosed.

The present invention has been accomplished in order to solve the above-mentioned problems, and the object is to provide a time-series document summarization device, a time-series document summarization method, and a computer-readable recording medium which are capable of outputting an appropriate summary sentence from a document collection.

### Means for Solving the Problems

For solving the problems mentioned above, a time-series document summarization device according to an aspect of the present invention is the time-series document summarization device for outputting a summary sentence of a document-of-interest collection that is a document collection to be an object, comprising:

a background topic word extraction part configured to acquire a set of said document-of-interest collection and a document-of-interest topic word that is a feature word of said document-of-interest collection, and a reference-use document collection that is a document collection different from said document-of-interest collection, and extract a background topic word representing a topic to be a background of a topic described in said document-of-interest collection from said reference-use document collection; and

a representative character string extraction part configured to extract a representative character string including said document-of-interest topic word and said background topic word as a summary sentence of said document-of-interest collection from among character strings included in said document-of-interest collection.

For solving the problems mentioned above, a time-series document summarization method according to an aspect of the present invention is the time-series document summarization method for outputting a summary sentence of a document-of-interest collection that is a document collection to be an object, comprising the step of:

acquiring a set of said document-of-interest collection and a document-of-interest topic word that is a feature word of said document-of-interest collection, and a reference-use document collection that is a document collection different from said document-of-interest collection, and extracting a background topic word representing a topic to be a background of a topic described in said document-of-interest collection from said reference-use document collection; and

extracting, from among character strings included in said document-of-interest collection, a representative character string including said document-of-interest topic word and said background topic word as a summary sentence of said document-of-interest collection.

For solving the problems mentioned above, a computer-readable recording medium according to an aspect of the present invention where recorded is a time-series document summarization program used in a time-series document summarization device configured to output a summary sentence of a document-of-interest collection that is a document collection to be an object, said time-series document summarization program being a program configured to make a computer execute the steps of:

acquiring a set of said document-of-interest collection and a document-of-interest topic word that is a feature word of said document-of-interest collection, and a reference-use document collection that is a document collection different from said document-of-interest collection, and extracting a background topic word representing a topic to be a background of a topic described in said document-of-interest collection from said reference-use document collection; and

extracting a representative character string including said document-of-interest topic word and said background topic word as a summary sentence of said document-of-interest collection from among character strings included in said document-of-interest collection.

### Effect of the Invention

According to the present invention, an appropriate summary sentence can be outputted from a document collection.

### BRIEF DESCRIPTION OF THE DRAWINGS

FIG. 1 is a figure illustrating examples of topics in a micro blog in one day;

FIG. 2 is a figure illustrating feature words and a text including the feature words in each period with respect to examples of FIG. 1;

FIG. 3 is a schematic configuration diagram of a time-series document summarization device according to the embodiment of the present invention;

FIG. 4 is a block diagram showing a control structure which the time-series document summarization device according to the first embodiment of the present invention provides;

FIG. 5 is a flow chart indicating an operation procedure when the time-series document summarization device according to the embodiment of the present invention;

FIG. 6 is a figure illustrating an example of data outputted by the document-of-interest topic word extraction part 10;

FIG. 7 is a figure illustrating an example of data outputted by the background topic word extraction part 20;

FIG. 8 is a figure illustrating an example of a summarization score of a character string in the representative character string extraction part 30;

FIG. 9 is a figure illustrating an example of data outputted by the representative character string extraction part 30;

Hereinafter, an embodiment of the present invention will be described using the figures. It is noted that the same reference character will be given to the same or corresponding part in the figures, and thus the description will not be repeated.

First, in order to make understanding of the present invention easy, problems which the present invention will solve will be described in detail.

It is considered that a text which a human being produces is made up of two parts when classified largely. That is, the two parts are a part describing a “background” representing about what the text describes and a part describing “new information” which a writer wants to convey by the text. As for this, not only a text written using characters, but also an oral utterance is the same.

Here, the “Background” means a topic to be a premise and a subject matter to be described, or the like, which are needed for understanding a text.

On the other hand, the “new information” means a matter which a writer wants to assert through the text, such as a description of a new fact, an opinion, and a comment related to a topic and subject matter described as a background.

Besides, although the “new information” is referred to generically here, the “new information” means information which a writer wants to convey to readers or information which a writer wants to assert, and it may not always be limited to information completely unknown for readers.

That is, even if a part which a writer wants to convey to readers through the text is a reconfirmation of a fact which readers may already know, this part is also made to be widely included in the new information. In addition, the new information, even if not a description of a fact, may be an opinion or comment of the writer.

For example, in a news article of the next day of the day when a game of Japan versus Denmark of Soccer World Cup was held, it is assumed that “as for the game of Japan versus Denmark of Soccer World Cup, Japan won by 3 to 1” has been written. At this time, a part of “a game of Japan versus Denmark of Soccer World Cup,” is a description of a background indicating about what the text is written, and a part of “Japan won by 3 to 1” is a description of new information which a writer wants to convey through the text.

A part to be a main which a writer wants to convey through a text is a description of new information. Since a description of a background is not new information, when information is conveyed to a specific partner who has already shared the information on the background, omission thereof is possible.

On the other hand, when information is conveyed, through a text, to many and unspecified partners who do not necessarily share information on the background, it is necessary to describe not only new information, but also the background to be a premise first.

For example, since many and unspecified readers who do not necessarily share information on a background are assumed in a news article, new information is described after a background is described like “as for a game of Japan versus Denmark of Soccer World Cup, Japan won by 3 to 1”.

On the other hand, when intimate friends talk on a day following the game, talking to others that “Japan won by 3 to 1 !” without a description about a background is also natural. This is based on an expectation that if it is the next day of the game, it is obvious what is talked about without explanation in particular, and even if a background is omitted, a partner will guess what is talked about.

In this way, there is a tendency that the more public a text (utterance) may be for being conveyed to many and unspecified persons, the more detailed a description of a background becomes, and the more private a text (utterance) may be for being conveyed to a specific small number of partners, the more omitted is a description of a background.

It was a news article and a blog article that a conventional trend analysis technology has made an object. Texts included in these documents are the texts which are widely exhibited assuming being read by many and unspecified persons, and a description of a topic to be a background is included in the documents in many cases so that contents which a writer wants to convey may be understood even when read by many and unspecified readers.

Consequently, when a news article and a blog article are made to be an analysis object like a conventional way, only by extracting texts including a lot feature words from a summarizing object document using technologies included in Non-patent Documents 1 to 3, it has been able to output summary sentences appropriate for many and unspecified readers, which includes a description of a topic to be a background.

On the other hand, a service of a new type referred to as a micro blog has propagated largely in the past several years. Twitter is the representative case. A micro blog is a service where an individual is able to post a text written by self in the same way as a blog. A user is able to post a short text of about 140 characters at the maximum. In the micro blog, what people consider daily is able to be freely posted on the Internet in real time.

In such a micro blog, a text where it is assumed that only specific people who are referred to as a follower and who have registered for reading a user's text will read is posted in many cases, and a utilizing method which is approximate to a private daily conversation has propagated. The number with which a user is followed up is approximately tens to hundreds of people except for some exceptions, and a user is able to post a text assuming a specific small number of readers who share information on a background.

In a micro blog, because of these characteristics, when many texts posted to the micro blog are accumulated, it is considered that many texts where a specific small number of readers are assumed are included as compared with the case where a conventional news article and a blog are accumulated. Then, in such a text, like a conversation among intimate friends, a part which will be a description with respect to a background is omitted in many cases.

By a method such that many texts posted to a micro blog like this may be accumulated and a text including a feature word may be extracted simply using a conventional technology, it is difficult to output an appropriate summary sentence.

The reason is as follows. That is, in a micro blog, the number of texts towards a specific small number of readers are extremely large, and almost all texts included in a micro blog are texts where a topic to be a background is not described. Therefore, even if a text including a feature word is selected as a summary sentence based on a statistical appearance tendency of a word or an expression, a text where a part to be a background description is not included is likely to be selected stochastically.

However, a large majority of readers who do not know about a background originally, even if a text like this is presented as a summary sentence of the original document collection and is read, are not able to understand about what the text is written, and therefore, a text like this will be inappropriate as a summary sentence.

For example, it is assumed that a game of Japan versus Denmark of Soccer World Cup is broadcast. Furthermore, it is assumed that the second point goal has been just successful currently during the game. In this case, “a shoot has been successful” and “a goal has been carried out” are new information at a current time. On the other hand, “Soccer World Cup” and “Japan versus Denmark” or the like are topics to be a background specifying about what talk “a shoot has been successful” and “a goal has been carried out” really is.

At this time, in a micro blog, texts where only the current new information such as “Oh! the shoot has been successful”, “Wow! It's the goal!” is made to be conveyed and a description of a background is omitted are posted a lot. A contributor of these texts carries out posting toward a specific small number of readers who are able to guess about what the contributor has written and who share the background. In many cases, also a timing at which the posted text is read is not largely shifted from the time at which the text has been posted.

On the other hand, a text including a description of a topic to be a background such as “in the game of Japan versus Denmark of Soccer World Cup, the second point goal has been just successful now” is small in the number as compared with the number of posting in the whole micro blog. This is because an explanatory text like this is used in a public media, and is not used in a private text and conversation.

From such a reason, although a frequent appearance word such as a “shoot” and “goal” is largely extracted as a feature word at that time in a micro blog, a word indicating a topic to be a background such as “Soccer World Cup”, “Japan”, and “Denmark” decreases as a frequency, and becomes hard to be extracted as a feature word.

As a result, only by extracting a text including a lot feature words in a certain period-of-interest from a micro blog, arises a tendency where a text which includes only a feature word representing new information such as “the shoot successful!” and “it's the goal! I'm glad” and which does not include a word representing a topic to be a background is likely to be extracted as a summary sentence. A summary sentence which is made up only of new information like this is difficult to understand for a reader of a third party who does not know a topic to be a background, and is not suitable as a summary sentence.

As mentioned above, only by extracting simply a text including a feature word using a conventional technology, it is not able to output from a micro blog an appropriate summary sentence which is easy to understand also for many and unspecified general readers.

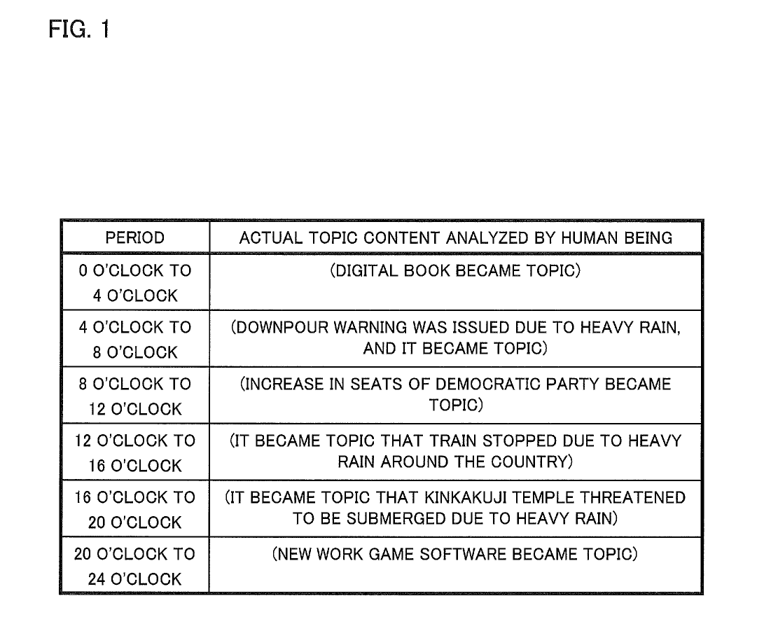

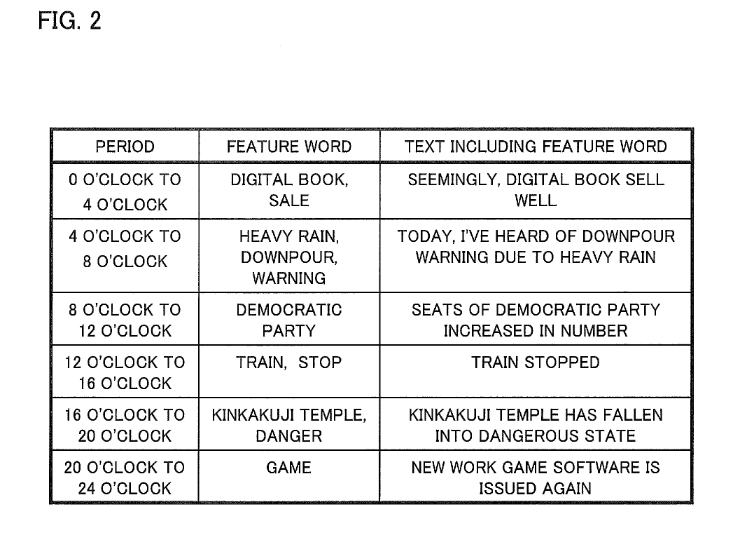

Furthermore, a specific example of this problem will be described using FIGS. 1 and 2.

FIG. 1 illustrates examples of topics in a micro blog in one day. FIG. 2 illustrates feature words and a text including the feature words in each period with respect to examples of FIG. 1.

FIGS. 1 and 2 are figures describing a change of a topic within a document collection posted during one day in a certain micro blog. It is assumed that one day is divided into six periods every four hours, and one text where topics included in documents posted in the period are summarized is outputted for every period. Therefore, it is assumed that a total of six summary sentences are outputted in one day.

FIG. 1 is assumed to represent results where a human being's operator reads and analyzes the posted documents and examines what kind of matters have become topics. This day is the day when every region of Japan was attacked by a heavy rain, it is understood that in the three time zones of “4:00 to 8:00”, “12:00 to 16:00” and “16:00 to 20:00”, topics with respect to the heavy rain have built up.

Since a topic in “12:00 to 16:00” and “16:00 to 20:00” is a topic of the heavy rain following “4:00 to 8:00” of the beginning, when periods of “12:00 to 16:00” and “16:00 to 20:00” are summarized, it is preferred that summary sentences including a description of a topic to be a background are outputted.

FIG. 2 is the result where with respect to the same document collection as FIG. 1, feature words in each period and a text including the feature words are extracted. Texts indicated in FIG. 2 have not been able to output summary sentences including a description of a topic to be the background that is a heavy rain.

That is, “Today, I've heard of the downpour warning due to a heavy rain”, “Trains have stopped” and “Kinkakuji Temple has fallen into a dangerous state” are extracted, and certainly, every text includes feature words of each period. However, only by reading these extracted texts, it is not able to be understood that there is a common background that is a heavy rain in these three occurrences.

It is because only a condition “to include a feature word of the period-of-interest” is taken into consideration when a summary sentence of each period is generated that a summary sentence including a description of a topic to be a background is not able to be outputted by this method. Consequently, it is necessary to add a condition such that a summary sentence including a description of a topic to be a background may be outputted.

Based on the above-mentioned idea, a time-series document summarization device according to an embodiment of the present invention makes it a clue that a feature word of a past period prior to a period-of-interest is used. Thereby, it is able to output, from a huge amount of documents having time information, a summary sentence which summarizes topics in a certain period and includes a description of a topic to be a background.

The time-series document summarization device 201 according to the embodiment of the present invention, typically, includes a computer which has a general-purpose architecture as a basic structure, and provides various functions described later by executing a program installed in advance. Generally, a program like this circulates in a state of being stored in a recording medium such as a flexible disk (Flexible Disk) and a CD-ROM (Compact Disk Read Only Memory), or via a network, etc. In the case where a general-purpose computer like this is used, in addition to an application for providing functions according to the embodiment of the present invention, an OS (Operating System) for providing a fundamental function of the computer may be installed. In this case, a program according to the embodiment of the present invention may be what executes processing by calling a required module in a prescribed order and/or timing within program modules provided as a part of the OS. That is, a program itself according to the embodiment of the present invention may not include above modules, and processing may be executed by collaborating with the OS. Therefore, as a program according to the embodiment of the present invention, it may have a configuration which does not include modules as mentioned above.

Furthermore, a program according to the embodiment of the present invention may be provided with being incorporated in a part of other programs such as an OS. Also in this case, a program itself according to the embodiment of the present invention does not include modules which other programs of the incorporation destination have as mentioned above, and the processing is executed by collaborating with the other programs. That is, as a program according to the embodiment of the present invention, it may have a configuration which is incorporated in other programs like this.

Besides, alternatively, a part or all of functions which are provided by the program execution may be implemented as dedicated hardware circuitry.

[Apparatus Configuration]

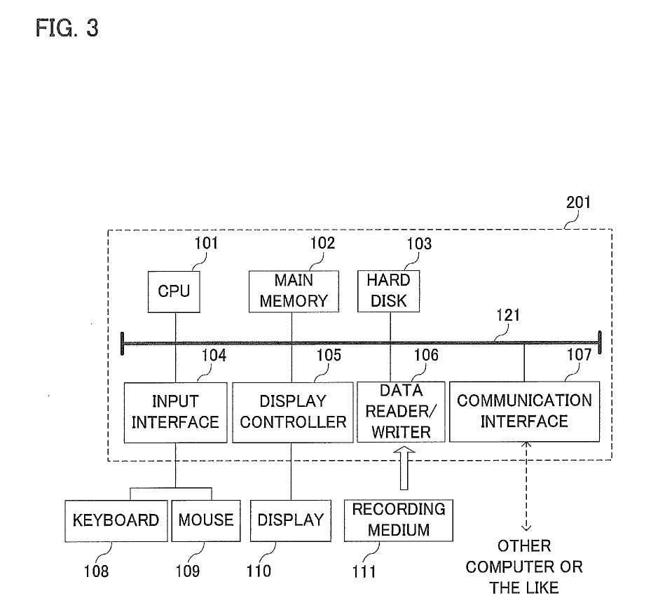

FIG. 3 is a schematic configuration diagram of the time-series document summarization device according to the embodiment of the present invention.

With reference to FIG. 3, the time-series document summarization device 201 is an information processing apparatus such as a portable information terminal, a personal computer and a server, and comprises: a CPU (Central Processing Unit) 101 which is an arithmetic processing unit; a main memory 102 and a hard disk 103; an input interface 104; a display controller 105; a data reader/writer 106; and a communication interface 107. Each of these parts is connected in a manner where data communication is possible mutually via a bus 121.

The CPU 101 carried out various calculations by reading out programs (code) stored in the hard disk 103 and writing to the main memory 102, and executing these in prescribed order.

The main memory 102 typically is a volatile storage device such as a DRAM (Dynamic Random Access Memory), and holds data etc. which indicate various arithmetic processing results in addition to programs read from the hard disk 103. The hard disk 103 is nonvolatile magnetic storage device, and various setting values etc. are stored in addition to the programs executed by the CPU 101. Programs installed on this hard disk 103 circulate in a state of being stored in a recording medium 111 as described later. Besides, in addition to the hard disk 103, or in place of the hard disk 103, a semiconductor memory such as a flash memory may be adopted.

The input interface 104 intermediates data transmission between the CPU 101 and a keyboard 108, a mouse 109 and an input unit such as a touch panel which is not illustrated. That is, the input interface 104 accepts an input from the outside, such as operation command given by a user operating the input unit.

The display controller 105 is connected with a display 110 which is a typical example of a display unit, and controls display on the display 110. That is, the display controller 105 displays to a user a result or the like of image processing by the CPU 101. The display 110 is a LCD (Liquid Crystal Display) or a CRT (Cathode Ray Tube), for example.

The data reader/writer 106 intermediates data transmission between the CPU 101 and the recording medium 111. That is, the recording medium 111 circulates in a state where programs etc. executed by the time-series document summarization device 201 is stored, and the data reader/writer 106 reads the programs from this recording medium 111.

The data reader/writer 106, in response to an internal command of the CPU 101, writes a processing result, etc. in the time-series document summarization device 201 to the recording medium 111. Besides, the recording medium 111 is, for example, a general-purpose semiconductor storage device such as a CF (Compact Flash) and a SD (Secure Digital), a magnetic storage medium such as a flexible disk (Flexible Disk), or an optical storage medium such as a CD-ROM (Compact Disk Read Only Memory).

The communication interface 107 intermediates data transmission between the CPU 101 and a personal computer, a server device or the like. The communication interface 107, typically, has a communication function of Ethernet® or a USB (Universal Serial Bus). Besides, in place of a configuration where programs stored in the recording medium 111 are installed on the time-series document summarization device 201, programs downloaded from a distribution server etc. via the communication interface 107 may be installed on the time-series document summarization device 201.

To the time-series document summarization device 201, other output apparatuses, such as a printer, may be connected as necessary.

[Control Structure]

Then, a control structure for providing various functions in the time-series document summarization device 201 will be described.

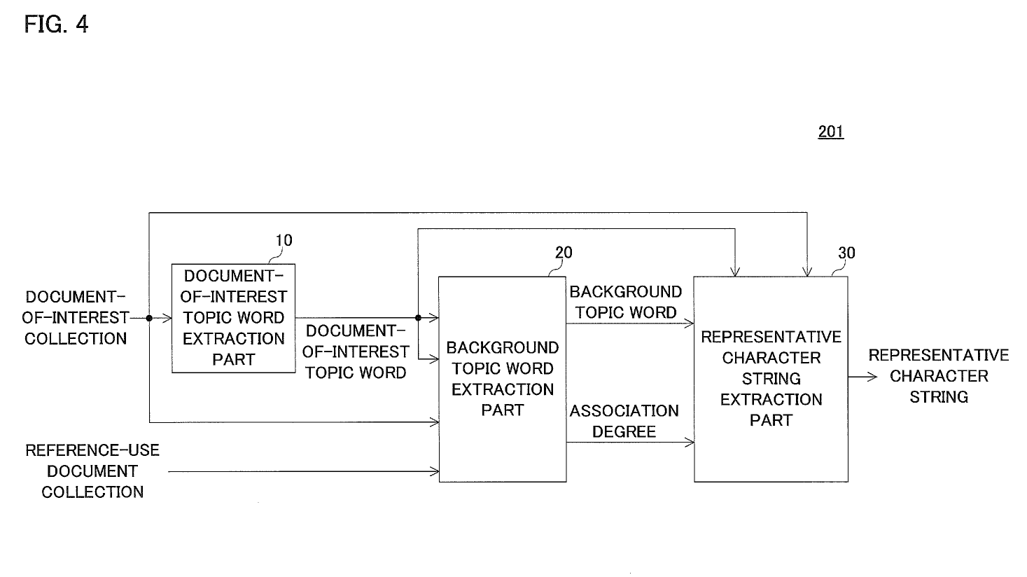

FIG. 4 is a block diagram showing a control structure which the time-series document summarization device according to the first embodiment of the present invention provides.

Each block of the time-series document summarization device 201 shown in FIG. 4 is provided by reading out programs (code) etc. stored in the hard disk 103 and writing to the main memory 102, and making the CPU 101 execute them. Besides, a part or all of modules shown in FIG. 4 may be provided by a firmware implemented in hardware. Alternatively, a part or all of control structures shown in FIG. 4 may be realized by dedicated hardware and/or a wiring circuit.

With reference to FIG. 4, the time-series document summarization device 201, as a control structure, includes: a document-of-interest topic word extraction part 10; a background topic word extraction part 20; and a representative character string extraction part 30.

The time-series document summarization device 201 accepts a document collection having time information as an input. The document collection having time information means a document collection such that a document included in the collection may be associated with a certain time. A time associated with each document represents a time when the document is created, and a time when the document is issued, or the like. The time may be described by any grading such as Year, Month, Day, Hour, Minute, and Second.

As an example of a document collection having time information which the time-series document summarization device 201 accepts as an input, there are a news article, a blog, a micro blog, and a document posted to an electronic bulletin board or the like.

The time-series document summarization device 201 summarizes topics of an inputted document collection. The inputted document collection is referred to as a document-of-interest collection. That is, the time-series document summarization device 201 creates a summary sentence of the document-of-interest collection that is a document collection to be an object.

In the time-series document summarization device 201, the document-of-interest topic word extraction part 10 makes an inputted document collection having time information a document-of-interest collection. Then, the document-of-interest topic word extraction part 10 extracts a feature word representing a topic of the document-of-interest collection as a document-of-interest topic word, and outputs it.

The background topic word extraction part 20 makes a document collection different from the document-of-interest collection a reference-use document collection. For example, this document collection differs from a document collection that is a dictionary such as a glossary. Besides, the reference-use document collection may be a document collection having time information, and may be a document collection not having time information.

The background topic word extraction part 20, from the reference-use document collection, extracts a feature word representing a topic of a past period prior to a period of the document-of-interest collection as a background topic word. Then, the background topic word extraction part 20 calculates an association degree representing an association between the extracted background topic word and the document-of-interest topic word which the document-of-interest topic word extraction part 10 outputs, and outputs the calculated association degree and the background topic word.

The representative character string extraction part 30, in addition to the document-of-interest topic word representing a topic of the document-of-interest collection extracted by the document-of-interest topic word extraction part 10, extracts a representative character string representing a topic of the document-of-interest collection using the background topic word extracted by the background topic word extraction part 20 and the calculated association degree.

[Operation]

Next, an operation of the time-series document summarization device according to the embodiment of the present invention will be described using drawings. In the embodiment of the present invention, the time-series document summarization method according to the embodiment of the present invention is carried out by operating the time-series document summarization device 201. Therefore, a description of the time-series document summarization method according to the embodiment of the present invention will be substituted by the following operation description of the time-series document summarization device 201. Besides, in the following description, FIG. 4 will be referred to suitably.

In the time-series document summarization device 201, the document-of-interest topic word extraction part 10 acquires the document-of-interest collection, and extracts, as a document-of-interest topic word, a word which is included in the document-of-interest collection and represents a topic of the document-of-interest collection.

The background topic word extraction part 20 acquires a set of the document-of-interest collection and a document-of-interest topic word that is the feature word of the document-of-interest collection extracted by the document-of-interest topic word extraction part 10, and acquires the reference-use document collection that is a document collection different from the document-of-interest collection. For example, the background topic word extraction part 20 acquires, as a reference-use document collection, a document collection including documents created or exhibited in the past prior to the document-of-interest collection.

Then, the background topic word extraction part 20 extracts, from the reference-use document collection, a background topic word representing a topic to be a background of a topic described in the document-of-interest collection. For example, the background topic word extraction part 20 extracts, as a background topic word, a word included a lot in the reference-use document collection or a word included in a biased state therein.

The representative character string extraction part 30, from among character strings included in the document-of-interest collection, extracts a representative character string including the document-of-interest topic word and the background topic word as a summary sentence of the document-of-interest collection.

In more details, the background topic word extraction part 20 calculates an association degree between the document-of-interest topic word and the background topic word. For example, the background topic word extraction part 20 calculates an association degree based on the in-document co-occurrence or an in-document similarity of a co-occurrence word of the document-of-interest topic word and background topic word, in at least one of the document-of-interest collection and the reference-use document collection.

The representative character string extraction part 30, based on an association degree calculated by the background topic word extraction part 20, calculates a score of a character string included in the document-of-interest collection and makes a character string having a high score a representative character string.

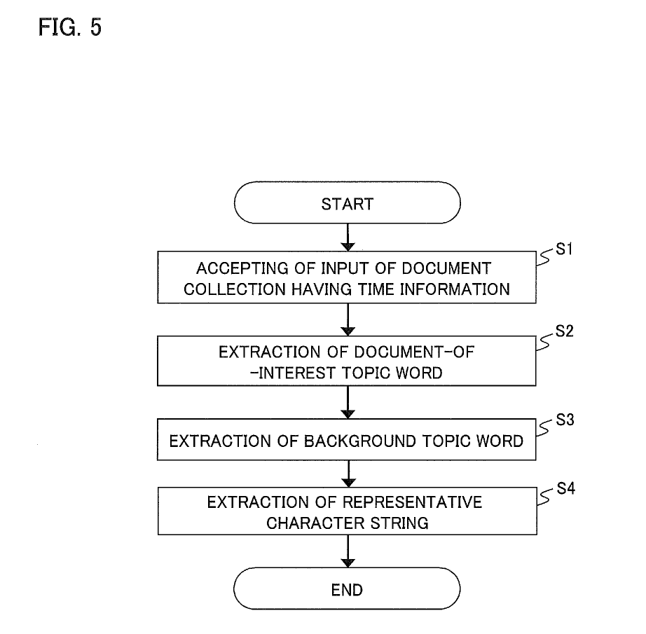

FIG. 5 is a flow chart indicating an operation procedure when the time-series document summarization device according to the embodiment of the present invention performs a time-series document summarization processing.

With reference to FIG. 5, first, the document-of-interest topic word extraction part 10 accepts an input of a document collection having time information from a user (Step S1).

Next, the document-of-interest topic word extraction part 10 makes the inputted document collection having time information a document-of-interest collection. Then, the document-of-interest topic word extraction part 10 extracted, as a document-of-interest topic word, a feature word representing a topic of the document-of-interest collection, and outputs it (Step S2).

Next, the background topic word extraction part 20 makes a document collection different from the document-of-interest collection a reference-use document collection. The background topic word extraction part 20, from the reference-use document collection, extracts a feature word representing a topic of a past period prior to a period of the document-of-interest collection as a background topic word. Then, the background topic word extraction part 20 calculates an association degree representing an association between the document-of-interest topic word outputted by the document-of-interest topic word extraction part 10 and the background topic word, and outputs the calculated association degree and the background topic word (Step S3).

Next, the representative character string extraction part 30, in addition to the document-of-interest topic word representing a topic of the document-of-interest collection extracted by the document-of-interest topic word extraction part 10, extracts a representative character string representing a topic of the document-of-interest collection using the background topic word extracted by the background topic word extraction part 20 and the association degree calculated by the background topic word extraction part 20 (Step S4).

Here, an operation of Step S1 will be described specifically. In the present embodiment, a user performs an input of a document collection having time information into the document-of-interest topic word extraction part 10 by using a keyboard 108 or the like.

Besides, a user may perform the input of the document collection having time information into the document-of-interest topic word extraction part 10 by using an external computer or the like connected with the time-series document summarization device 201 via a communication interface 107 and network. Alternatively, a user may perform an input of a document collection having time information by specifying a data file which stores the document collection having time information. In this case, the document-of-interest topic word extraction part 10 reads the document collection having time information from the data file specified by a user.

Next, an operation of Step S2 will be described specifically. In the present embodiment, the document-of-interest topic word extraction part 10 makes the inputted document collection having time information a document-of-interest collection. Then, the document-of-interest topic word extraction part 10 extracts and outputs a feature word representing a topic of the document-of-interest collection as a document-of-interest topic word.

Here, as for an extraction method of a feature word representing a topic of the document-of-interest collection, various methods are considered. For example, with respect to each word, the number of appearance in a document within the period is made to be counted, and words are made to be ranked in descending order of the number of appearance. Then, it is able to assume N words of higher order to be a feature word which appears in a biased state in the period.

In addition, as for an extraction method of a feature word representing a topic of a document-of-interest collection, heretofore known various extraction technologies for a feature word are able to be used. For example, a feature word of a document may be extracted using a technology described in pages 22 to 23 of Non-patent Document 3.

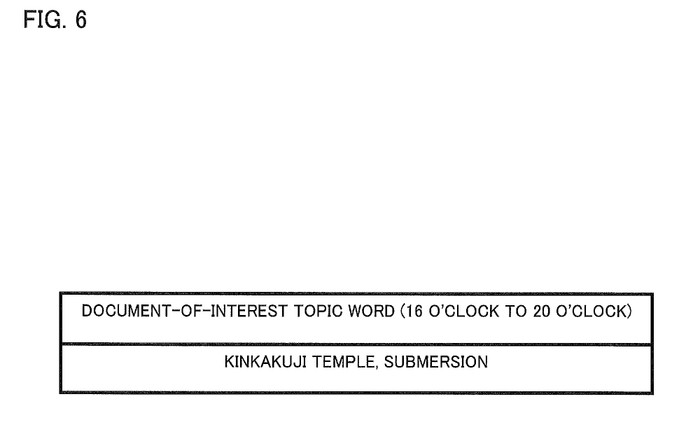

FIG. 6 illustrates an example of data outputted by the document-of-interest topic word extraction part 10.

With respect to FIG. 6, in this example, a document collection posted to a certain micro blog from 16 o'clock to 20 o'clock is made to be a document-of-interest collection, and a topic word included in this document-of-interest collection has been extracted.

Next, an operation of Step S3 will be described specifically. The background topic word extraction part 20 makes a document collection different from the document-of-interest collection a reference-use document collection. The background topic word extraction part 20, from the reference-use document collection, extracts a feature word representing a topic of a past period prior to a period of the document-of-interest collection as a background topic word. Then, the background topic word extraction part 20 calculates an association degree representing an association between the document-of-interest topic word outputted by the document-of-interest topic word extraction part 10 and the background topic word, and outputs the calculated association degree and the background topic word.

Here, as a reference-use document collection, a document collection where it is expected that a past topic prior to a topic of the document-of-interest collection is included is used. As a document collection where it is expected that this past topic is included, a document collection created or exhibited in the past prior to the document-of-interest collection is able to be used.

For example, it is assumed that an inputted document-of-interest collection was a document collection posted from 16 o'clock to 20 o'clock in a certain micro blog. At this time, as a reference-use document collection, a document collection posted to the same micro blog during from 0 o'clock to 16 o'clock is able to be used, for example.

Alternatively, like a news article and another blog, a document source different from a micro blog to which the document-of-interest collection belongs may be used. However, even in the case where another document source is used, the source is needed to be a document collection where it is expected that a past topic prior to the time to which the document-of-interest collection belongs is included.

In addition, if a reference-use document collection is a document collection where it is expected that a past topic prior to a topic of the document-of-interest collection is included, a time when the reference-use document collection was created or exhibited may be far apart from the time when the document-of-interest collection was created or exhibited, or may have an overlap therewith. For example, in the above-mentioned example, as a reference-use document collection, a document collection posted from 0 o'clock to 6 o'clock may be used, or a document collection posted from 3 o'clock to 18 o'clock may be used.

The background topic word extraction part 20 extracts a feature word representing a topic of a past period prior to a period of the document-of-interest collection from the reference-use document collection as a background topic word. As for an extraction method of the background topic word, the same method as having extracted a document-of-interest topic word from the document-of-interest collection may be used in the document-of-interest topic word extraction part 10, or a different method from that may be used.

Most simply, the same method as having extracted a document-of-interest topic word from the document-of-interest collection is made to be applied to the reference-use document collection in the document-of-interest topic word extraction part 10. Thereby, a feature word representing a topic of a past period prior to a period of the document-of-interest collection is able to be extracted as a background topic word.

In addition, the reference-use document collection is made to be further divided in several periods, and with respect to each divided document collection, the same method as having extracted a document-of-interest topic word from the document-of-interest collection may be applied in the document-of-interest topic word extraction part 10.

For example, as the reference-use document collection, when a document collection posted during from 0 o'clock to 16 o'clock is used, the document collection may be made to be divided into documents posted in four periods of “0 o'clock to 4 o'clock”, “4 o'clock to 8 o'clock”, “8 o'clock to 12 o'clock”, and “12 o'clock to 16 o'clock”, and a feature word in the each document collection may be extracted as a background topic word.

The background topic word extraction part 20, after having extracted a background topic word as mentioned above, calculates an association degree representing an association between the document-of-interest topic word outputted by the document-of-interest topic word extraction part 10 and the background topic word.

As an association degree representing an association between the document-of-interest topic word and the background topic word, various ones are considered. Hereinafter, while the document-of-interest topic word and the background topic word are made to be A and B, respectively, an example of a value considered as an association degree representing an association between A and B will be described.

As an association degree representing an association between the document-of-interest topic word and the background topic word, an intensity of co-occurrence where two words appear in a document may be used.

For example, the number of documents where both of the word A and B appear within a document collection is made to be N1, and the number of documents where either of the word A and the word B appears is made to be N2. Then, it is possible that N1/N2 is made to be an association degree representing an association between two words. The larger this value is, it is represented that the more strongly the two words co-occur and appear. As a method of counting of the number of documents, only the number of documents in the document-of-interest collection may be counted, and the number of documents in the document-of-interest collection and reference document collection may be counted together. In addition, although accuracy is worse as compared with these, only the number of documents in the reference document collection may be counted.

In addition, as an association degree representing an association between the document-of-interest topic word and the background topic word, a similarity between a co-occurrence word of document-of-interest topic words and a co-occurrence word of background topic words, specifically a similarity between a context where the document-of-interest topic word appears and the context where a background topic word appears may be used.

That is, the total number of all the words is made to be Nw, and with respect to the word A and the word B, a vector having a length Nw representing each context is able to be considered. It is assumed that each element of the vector represents a magnitude of a number of times where a certain word has co-occurred with the word A or the word B. At this time, by calculating a cosine similarity between a vector representing a context of the word A and a vector representing a context of the word B, it is possible that the cosine similarity is made to be the similarity of contexts of the word A and the word B. This similarity may be made to be an association degree representing an association between two words.

In addition, as an association degree representing an association between the document-of-interest topic word and the background topic word, an existence of an association in a dictionary where an association of words is described may be used.

For example, when a thesaurus in a tree structure form representing a super-sub-relation of words has been acquired, an inverse number of a distance between nodes representing two words in this thesaurus tree structure may be made to be an association degree representing an association between two words.

In addition, as an association degree representing an association between the document-of-interest topic word and the background topic word, temporal appearance proximity may be used.

For example, it is assumed that an average of a time when a document where the word A appears has been created or exhibited is Ta, and an average of a time when a document where the word B appears has been created or exhibited is Tb. At this time, an inverse number of a temporal distance between Ta and Tb may be made to be an association degree representing an association between two words.

In addition, as an association degree representing an association between the document-of-interest topic word and the background topic word, a value where various association degrees included in the above are combined may be used.

For example, when an association degree calculated using an intensity of co-occurrence where two words appear in a document is made to be V1, and an association degree calculated using a temporal appearance proximity is made to be V2, V1+V2 may be outputted as an association degree in place of V1 and V2.

In addition, when an association degree representing an association between the document-of-interest topic word and the background topic word is calculated, a value representing a feature word identity of a background topic word is made to be calculated, and the value may be made to be taken into consideration in calculating an association degree.

For example, a magnitude of an appearance frequency in the reference-use document collection is assumed to be V3 as a value representing a feature word identity in the reference-use document collection. It is assumed that the large this value is, the more important the background topic word is, and by adding V3 to an association degree on the basis of other methods, the association degree of the background topic word may be evaluated highly.

As for a method of calculating an association degree between a word and a word, there are known arts which are generally known in the field of natural language processing also in addition to that. In the present embodiment, in order to calculate an association between a document-of-interest topic word and a background topic word, an association degree based on such known art may be used besides.

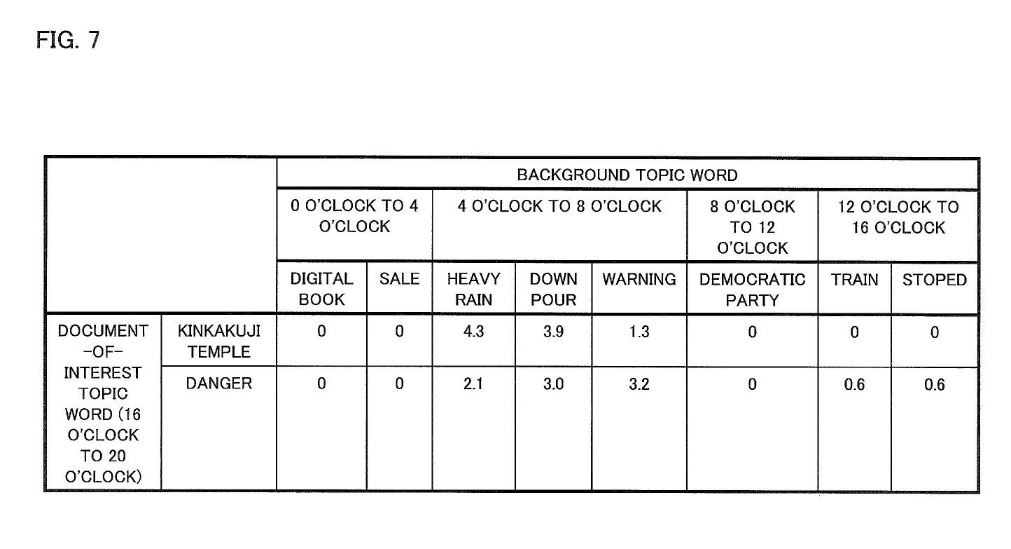

FIG. 7 illustrates an example of data outputted by the background topic word extraction part 20.

In FIG. 7, an association degree representing an association between a document-of-interest topic word and a background topic word is described. In FIG. 7, a column in a longitudinal direction represents a document-of-interest topic word, and a column in a lateral direction represents a background topic word.

This example is an example in the following assumption. That is, a document collection posted from 16 o'clock to 20 o'clock in a certain micro blog is made to be a document-of-interest collection. A document collection posted from 0 o'clock to 16 o'clock is made to be a reference document collection, and the document collection may be made to be divided into documents posted in four periods of “0 o'clock to 4 o'clock”, “4 o'clock to 8 o'clock”, “8 o'clock to 12 o'clock”, and “12 o'clock to 16 o'clock”, and a feature word in the each document collection may be extracted as a background topic word. Furthermore, an association degree representing an association between the document-of-interest topic word and the background topic word is made to be calculated.

As indicated in an example of FIG. 7, an association degree with the background topic word representing a topic to be a background for the document-of-interest topic word like a “heavy rain” and a “downpour” is calculated high. On the other hand, an association degree with the background topic word not representing a topic to be a background for the document-of-interest topic word like a “digital book” and “Democratic Party” is calculated low.

Next, an operation of Step S4 will be described specifically. The representative character string extraction part 30, in addition to the document-of-interest topic word representing a topic of the document-of-interest collection which the document-of-interest topic word extraction part 10 has extracted, extracts a representative character string representing a topic of the document-of-interest collection using the background topic word extracted by the background topic word extraction part 20 and the association degree calculated by the background topic word extraction part 20.

Specifically, among character strings included in a document within the document-of-interest collection, with respect to a character string such that any of document-of-interest topic words may be included and any of background topic words having a high association degree with the document-of-interest topic word may be included, an summarization score representing an adequacy as a summary sentence of the character string is made to be given. Then, a character string having a high summarization score is extracted as a representative character string representing a topic of the document-of-interest collection.

A method of determining a character string which will be an object to be extracted is optional. For example, by dividing all the documents within the document-of-interest collection using a symbol representing a text separation such as a period, it is possible to acquire all the texts included in a document within the document-of-interest collection.

A collection of these texts may be made to be character strings which will be an object to be extracted. In addition, by that all the documents within the document-of-interest collection are made to be divided for every N characters (N is an integer no more than 2), it is possible to acquire a collection of a character string having a N characters length. A collection of these character strings having a N characters length may be made to be the character string which will be an object to be extracted.

As a calculation method of a summarization score of a character string, for example, only a character string including any of document-of-interest topic words is made to be selected, and with respect to each of background topic words included in the selected character string, association degrees with document-of-interest topic words are made to be totaled, and the totaled value may be made to be a summarization score. In addition to that, a method of selecting an abstract character string from feature words as described in Non-patent Document 3 may be used.

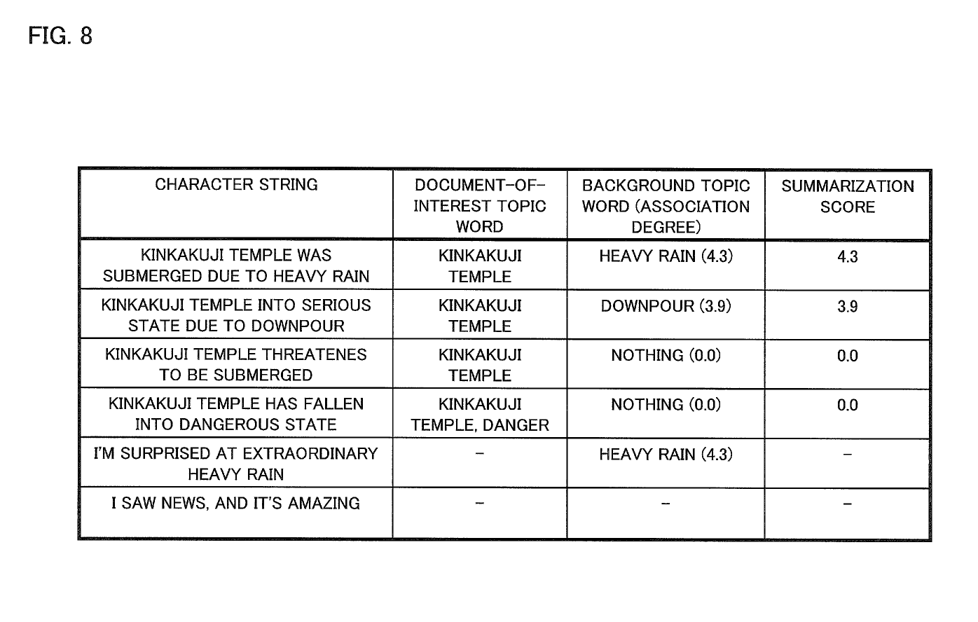

FIG. 8 illustrates an example of a summarization score of a character string in the representative character string extraction part 30. FIG. 8 indicates a summarization score of a character string included in documents in a document-of-interest collection when documents in a period of “16 o'clock to 20 o'clock” are made to be the document-of-interest collection.

The first column of FIG. 8 represents character strings included in documents in the document-of-interest collection. The second column represents document-of-interest topic words included in the character strings. The third column represents background topic words included in the character strings, and the association degrees. The fourth column represents summarization scores of the character strings calculated based on the third column.

In FIG. 8, a character string “Kinkakuji Temple was submerged due to heavy rain” has the highest summarization score. This is because the background topic word having a high association with the document-of-interest topic word that is “heavy rain” is included. It is considered that a text like this is a summary sentence including a description of a topic to be a background.

On the other hand, although the character string “Kinkakuji Temple has fallen into a dangerous state” includes two interest topic words, a summarization score of the character string has been low since a background topic word is not included. It is considered that a character string like this is a summary sentence which does not include a description of a topic to be a background.

On the other hand, although the character string “surprised at an extraordinary heavy rain” includes the background topic word of “heavy rain”, a summarization score of a character string has not been given. This is because even if a background topic word is included, it is considered that a character string which does not include an interest topic word is not suitable as an abstract of a topic of a period-of-interest.

As the result, as a representative character string when documents within a period of “16 o'clock to 20 o'clock” are made to be a document-of-interest collection, the character string “Kinkakuji Temple was submerged due to heavy rain” will be selected.

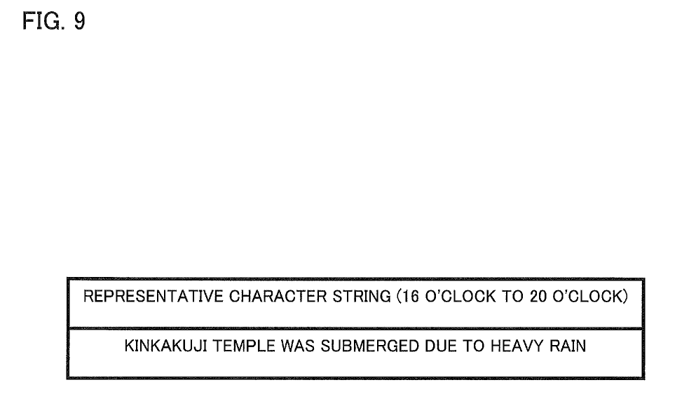

FIG. 9 illustrates an example of data outputted by the representative character string extraction part 30. In this example, the representative character string when documents within a period from 16 o'clock to 20 o'clock” is made to be the document-of-interest collection is indicated.

In FIG. 9, the associated background topic word of the “heavy rain” is included in the representative character string. Thereby, as compared with an example indicated in FIG. 2, the text including a description of a topic to be a background has been outputted. In addition, since the document-of-interest topic word that is “Kinkakuji Temple” is included, topics of the document-of-interest collection are summarized.

As described above, according to the time-series document summarization device 201 according to the present embodiment, it is able to output, from a huge amount of documents having time information, a summary sentence which summarizes topics in a certain period and includes a description of a topic to be a background.

By the way, based on a statistical appearance tendency of a word or expression, in the case where a conventional technology such that a sentence including a feature word may be selected as a summary sentence is used, a sentence in which a part which will be a description with respect to a background is not included is likely to be selected as a summary sentence stochastically. However, for general readers who do not know about a background originally are not able to understand about what the sentence is written, and there is a problem that the sentence becomes inappropriate as a summary sentence.

With respect to this, in the time-series document summarization device according to the embodiment of the present invention, the background topic word extraction part 20 acquires a set of a document-of-interest collection and a document-of-interest topic word that is a feature word of the document-of-interest collection and acquires a reference-use document collection that is a document collection different from the document-of-interest collection, and extracts a background topic word representing a topic to be a background of a topic described in the document-of-interest collection from the reference-use document collection. Then, the representative character string extraction part 30, from among character strings included in the document-of-interest collection, extracts a representative character string including the document-of-interest topic word and the background topic word as a summary sentence of the document-of-interest collection.

Here, as specific differences between technologies described in Patent Documents 1 to 3 and the time-series document summarization device according to the embodiment of the present invention, there are the following points, for example.

That is, in the technology described in Patent Document 1, topic words are combined in the case where a document sharing level in these topic words is high. That is, topic words which are likely to appear a lot in the same document are combined. Consequently, since a document-of-interest collection is not discriminated from a document collection different from the document-of-interest collection, two types of a document-of-interest topic word and a background topic word are not able to be discriminated and extracted.

As compared with this, in the time-series document summarization device according to the embodiment of the present invention, a document collection different from a document-of-interest collection is prepared and a feature word is extracted, and the extracted feature word is made to be a background topic word. Then, a character string including two types of a background topic word and a document-of-interest topic word is extracted from the document-of-interest collection.

In addition, in the technology described in Patent Document 2, an association degree between originating sources is calculated from a similarity of words and phrases included in documents created by each originating source in the past. In addition, in the technology described in Patent Document 3, an appearance frequency for every clock time of each word is made up, and only a word where the appearance frequency increases largely at any of parts within the period is extracted as a candidate word of a potential topic. In this way, the technologies described in Patent Documents 2 and 3 completely differ from a configuration where a background topic word representing a topic to be a background of a topic described in a document-of-interest collection is extracted from a reference-use document collection like the time-series document summarization device according to the embodiment of the present invention.

That is, in the time-series document summarization device according to the embodiment of the present invention, not only a feature word included in a document-of-interest collection, i.e. a document-of-interest topic word, but also a character string including further a word representing a topic to be a background, i.e. a background topic word are made to be extracted from among character strings included in the document-of-interest collection and are made to be extracted as a representative character string. In more details, a document collection different from a document-of-interest collection is made to be prepared, and a feature word of this document collection is made to be extracted as a background topic word, and a character string including two types of the background topic word and the document-of-interest topic word is made to be extracted from the document-of-interest collection.

That is, it will become possible to achieve an object of the present invention that among each constituent in the time-series document summarization device according to the embodiment of the present invention, based on a minimum configuration comprised of the background topic word extraction part 20 and the representative character string extraction part 30, an appropriate summary sentence is made to be outputted from a document collection.

In addition, in the time-series document summarization device according to the embodiment of the present invention, the background topic word extraction part 20 acquires a document collection including documents created or exhibited in the past prior to the document-of-interest collection as a reference-use document collection.

By such a configuration as this, it possible to acquire a document collection where high is the possibility that a past topic prior to a topic of the document-of-interest collection is included, and to acquire an appropriate background topic word.

In addition, in the time-series document summarization device according to the embodiment of the present invention, the background topic word extraction part 20 extracts a word included a lot or in a biased state in the reference-use document collection as a background topic word.

By such a configuration as this, an appropriate background topic word is able to be acquired more surely from among the reference-use document collection. That is, a word with respect to a content which has become a topic to some extent in the past is able to be acquired as a background topic word.

In addition, in the time-series document summarization device according to the embodiment of the present invention, the background topic word extraction part 20 calculates an association degree between a document-of-interest topic word and a background topic word. Then, the representative character string extraction part 30, based on an association degree calculated by the background topic word extraction part 20, calculates a score of a character string included in the document-of-interest collection, and makes the character string having a high score a representative character string.

By such a configuration as this, it is possible to evaluate quantitatively a character string included in the document-of-interest collection and to extract an appropriate representative character string. That is, a word with respect to a content which has become a topic currently is able to be acquired as a background topic word.

In addition, in the time-series document summarization device according to the embodiment of the present invention, the background topic word extraction part 20 calculates an association degree based on in-document co-occurrence or a in-document similarity of a co-occurrence word of the document-of-interest topic word and background topic word, in at least one of the document-of-interest collection and the reference-use document collection.

By such a configuration as this, a score of a character string included in the document-of-interest collection is able to be calculated appropriately.

In addition, in the time-series document summarization device according to the embodiment of the present invention, the document-of-interest topic word extraction part 10 acquires a document-of-interest collection, and extracts a word representing a topic of a document-of-interest collection included in the document-of-interest collection as a document-of-interest topic word. Then, the background topic word extraction part 20 acquires the document-of-interest topic word extracted by the document-of-interest topic word extraction part 10.

By such a configuration as this, a document-of-interest collection and a document-of-interest topic word are able to be acquired automatically, and as a device for creating a summary sentence of the document-of-interest collection, the device is able to function more comprehensively.

Besides, although the time-series document summarization device according to the embodiment of the present invention is made to be configured to include the document-of-interest topic word extraction part 10, it is not limited to this. The time-series document summarization device may be configured not to include the document-of-interest topic word extraction part 10, and may have a configuration where the background topic word extraction part 20 acquires a set of a document-of-interest collection and document-of-interest topic word from the outside of the time-series document summarization device 201. For example, the time-series document summarization device 201 may be configured to accept, from a user, specifying of a set of a document-of-interest collection and a document-of-interest topic word.

A part or all of the above-mentioned embodiments are described also as the following additional statements, and however, the scope of the present invention is not limited to the following additional statements.

Additional Statement 1

A time-series document summarization device configured to output a summary sentence of a document-of-interest collection that is a document collection to be an object, comprising:

a background topic word extraction part configured to acquire a set of said document-of-interest collection and a document-of-interest topic word that is a feature word of said document-of-interest collection, and a reference-use document collection that is a document collection different from said document-of-interest collection, and extract a background topic word representing a topic to be a background of a topic described in said document-of-interest collection from said reference-use document collection; and

a representative character string extraction part configured to extract a representative character string including said document-of-interest topic word and said background topic word as a summary sentence of said document-of-interest collection from among character strings included in said document-of-interest collection.

Additional Statement 2

The time-series document summarization device according to Additional statement 1, wherein

said background topic word extraction part acquires a document collection including documents created or exhibited in the past prior to said document-of-interest collection as said reference-use document collection.

Additional Statement 3

The time-series document summarization device according to Additional statement 2, wherein

said background topic word extraction part extracts a word included a lot or a word included in biased way in said reference-use document collection as said background topic word.

Additional Statement 4

The time-series document summarization device according to any of Additional statements 1 to 3, wherein

said background topic word extraction part calculates an association degree of said document-of-interest topic word and said background topic word, and

said representative character string extraction part, based on said association degree calculated by said background topic word extraction part, calculates a score of a character string included in said document-of-interest collection, and makes said character string having a high score said representative character string.

Additional Statement 5

The time-series document summarization device according to Additional statement 4, wherein

said background topic word extraction part calculates said association degree based on in-document co-occurrence or an in-document similarity of a co-occurrence word of said document-of-interest topic word and said background topic word, in at least one of said document-of-interest collection and said reference-use document collection.

Additional Statement 6

The time-series document summarization device according to any of Additional statements 1 to 5, wherein

said time-series document summarization device further comprises

a document-of-interest topic word extraction part configured to acquire said document-of-interest collection, and extract, as said document-of-interest topic word, a word representing a topic of said document-of-interest collection, which is included in said document-of-interest collection, and

said background topic word extraction part acquires said document-of-interest topic word extracted by said document-of-interest topic word extraction part.

Additional Statement 7

A time-series document summarization method for outputting a summary sentence of a document-of-interest collection that is a document collection to be an object, comprising the step of:

acquiring a set of said document-of-interest collection and a document-of-interest topic word that is a feature word of said document-of-interest collection, and a reference-use document collection that is a document collection different from said document-of-interest collection, and extracting a background topic word representing a topic to be a background of a topic described in said document-of-interest collection from said reference-use document collection; and

extracting, from among character strings included in said document-of-interest collection, a representative character string including said document-of-interest topic word and said background topic word as a summary sentence of said document-of-interest collection.

Additional Statement 8

The time-series document summarization method according to Additional statement 7, wherein

in a step of extracting said background topic word, a document collection including documents created or exhibited in the past prior to said document-of-interest collection is acquired as said reference-use document collection.

Additional Statement 9

The time-series document summarization method according to Additional statement 8, wherein

in a step of extracting said background topic word, a word included a lot or a word included in biased way in said reference-use document collection is extracted as said background topic word.

Additional Statement 10

The time-series document summarization method according to any of Additional statements 7 to 9, wherein

in a step of extracting said background topic word, an association degree of said document-of-interest topic word and said background topic word are calculated, and

in a step of extracting said representative character string, based on calculated said association degree, a score of a character string included in said document-of-interest collection is calculated, and said character string having a high score is made to be said representative character string.

Additional Statement 11

The time-series document summarization method according to Additional statement 10, wherein

in a step of extracting said background topic word, said association degree is calculated based on in-document co-occurrence or an in-document similarity of a co-occurrence word of said document-of-interest topic word and said background topic word, in at said document-of-interest collection or said reference-use document collection.

Additional Statement 12

The time-series document summarization method according to any of Additional statements 7 to 11, wherein

said time-series document summarization method further comprises a step of:

acquiring said document-of-interest collection and extracting a word representing a topic of said document-of-interest collection as said document-of-interest topic word, which is included in said document-of-interest collection, and

in a step of extracting said background topic word, extracted said document-of-interest topic word is acquired.

Additional Statement 13

A computer-readable recording medium where recorded is a time-series document summarization program used in a time-series document summarization device configured to output a summary sentence of a document-of-interest collection that is a document collection to be an object, said time-series document summarization program being a program configured to make a computer execute the steps of:

acquiring a set of said document-of-interest collection and a document-of-interest topic word that is a feature word of said document-of-interest collection, and a reference-use document collection that is a document collection different from said document-of-interest collection, and extracting a background topic word representing a topic to be a background of a topic described in said document-of-interest collection from said reference-use document collection; and

extracting a representative character string including said document-of-interest topic word and said background topic word as a summary sentence of said document-of-interest collection from among character strings included in said document-of-interest collection.

Additional Statement 14

The computer-readable recording medium according to Additional statement 13, wherein

in a step of extracting said background topic word, a document collection including documents created or exhibited in the past prior to said document-of-interest collection is acquired as said reference-use document collection.

Additional Statement 15

The computer-readable recording medium according to Additional statement 14, wherein

in a step of extracting said background topic word, a word included a lot or a word included in biased way in said reference-use document collection is extracted as said background topic word.

Additional Statement 16

The computer-readable recording medium according to any of Additional statements 13 to 15, wherein

in a step of extracting said background topic word, an association degree of said document-of-interest topic word and said background topic word are calculated, and

in a step of extracting said representative character string, based on calculated said association degree, a score of a character string included in said document-of-interest collection is calculated, and said character string having a high score is made to be said representative character string.

Additional Statement 17

The computer-readable recording medium according to Additional statement 16, wherein

in a step of extracting said background topic word, said association degree is calculated based on in-document co-occurrence or an in-document similarity of a co-occurrence word of said document-of-interest topic word and said background topic word, in said document-of-interest collection and said reference-use document collection.

Additional Statement 18

The time-series document summarization program according to any of Additional statements 13 to 17, wherein

said time-series document summarization program is a program configured to make a computer further execute a step of:

acquiring said document-of-interest collection and extracting a word representing a topic of said document-of-interest collection as said document-of-interest topic word, which is included in said document-of-interest collection, and

in a step of extracting said background topic word, extracted said document-of-interest topic word is acquired.

It should be considered that the above-mentioned embodiments are exemplifications and not restrictive in terms of all points. It is intended that the scope of the present invention is shown by the scope of Claims, and not by above-mentioned descriptions, and all modifications within the purport and limit equivalent to the scope of Claims are included therein.

As to this application, claimed is a priority right based on Japanese Patent Laid-Open No. 2011-29705 that is applied on Feb. 15, 2011, and all the disclosures are incorporated here.

### INDUSTRIAL APPLICABILITY

According to the present invention, in a micro blog for example, it is able to output, from a huge amount of documents having time information, a summary sentence which summarizes topics in a certain period and includes a description of a topic to be a background. Therefore, the present invention has industrial applicability.

### DESCRIPTION OF SYMBOLS

10 DOCUMENT-OF-INTEREST TOPIC WORD EXTRACTION PART
20 BACKGROUND TOPIC WORD EXTRACTION PART
30 REPRESENTATIVE CHARACTER STRING EXTRACTION PART
101 CPU
102 MAIN MEMORY
103 HARD DISK
104 INPUT INTERFACE
105 DISPLAY CONTROLLER
106 DATA READER/WRITER
107 COMMUNICATION INTERFACE
108 KEYBOARD
109 MOUSE
110 DISPLAY
111 RECORDING MEDIUM
121 BUS
201 TIME-SERIES DOCUMENT SUMMARIZATION DEVICE

What is claimed is:

1. A time-series document summarization device configured to output a summary sentence of a document-of-interest collection that is a document collection to be an object, comprising:
a background topic word extraction part configured to acquire a set of said document-of-interest collection and a document-of-interest topic word that is a feature word of said document-of-interest collection, and a reference-use document collection that is a document collection different from said document-of-interest collection, and extract a background topic word representing a topic to be a background of a topic described in said document-of-interest collection from said reference-use document collection; and
a representative character string extraction part configured to extract a representative character string including said document-of-interest topic word and said background topic word as a summary sentence of said document-of-interest collection from among character strings included in said document-of-interest collection.

2. The time-series document summarization device according to claim 1, wherein
said background topic word extraction part acquires a document collection including documents created or exhibited in the past prior to said document-of-interest collection as said reference-use document collection.

3. The time-series document summarization device according to claim 2, wherein
said background topic word extraction part extracts a word included a lot or a word included in biased way in said reference-use document collection as said background topic word.

4. The time-series document summarization device according to claim 1, wherein
said background topic word extraction part calculates an association degree of said document-of-interest topic word and said background topic word, and
said representative character string extraction part, based on said association degree calculated by said background topic word extraction part, calculates a score of a character string included in said document-of-interest collection, and makes said character string having a high score said representative character string.

5. The time-series document summarization device according to claim 4, wherein
said background topic word extraction part calculates said association degree based on in-document co-occurrence or an in-document similarity of a co-occurrence word of said document-of-interest topic word and said background topic word, in at least one of said document-of-interest collection and said reference-use document collection.

6. The time-series document summarization device according to claim 1, wherein
said time-series document summarization device further comprises
a document-of-interest topic word extraction part configured to acquire said document-of-interest collection, and extract, as said document-of-interest topic word, a word representing a topic of said document-of-interest collection, which is included in said document-of-interest collection, and
said background topic word extraction part acquires said document-of-interest topic word extracted by said document-of-interest topic word extraction part.

7. A time-series document summarization method for outputting a summary sentence of a document-of-interest collection that is a document collection to be an object, comprising the step of:
acquiring a set of said document-of-interest collection and a document-of-interest topic word that is a feature word of said document-of-interest collection, and a reference-use document collection that is a document collection different from said document-of-interest collection, and extracting a background topic word representing a topic to be a background of a topic described in said document-of-interest collection from said reference-use document collection; and
extracting, from among character strings included in said document-of-interest collection, a representative character string including said document-of-interest topic word and said background topic word as a summary sentence of said document-of-interest collection.

8. A computer-readable recording medium where recorded is a time-series document summarization program used in a time-series document summarization device configured to output a summary sentence of a document-of-interest collection that is a document collection to be an object, said time-series document summarization program being a program configured to make a computer execute the steps of:
acquiring a set of said document-of-interest collection and a document-of-interest topic word that is a feature word of said document-of-interest collection, and a reference-use document collection that is a document collection different from said document-of-interest collection, and extracting a background topic word representing a topic to be a background of a topic described in said document-of-interest collection from said reference-use document collection; and
extracting a representative character string including said document-of-interest topic word and said background topic word as a summary sentence of said document-of-interest collection from among character strings included in said document-of-interest collection.
